(19) United States
(12) Patent Application Publication
(10) Pub. No.: US 2012/0029978 A1
(43) Pub. Date: Feb. 2, 2012

(54) Economic Rewards for the Performance of Tasks by a Distributed Workforce

(75) Inventors: Benjamin P. Olding, San Francisco, CA (US); Nathan Norfleet Eagle, Boston, MA (US)

(73) Assignee: TXTEAGLE INC., San Francisco, CA (US)

(21) Appl. No.: 12/848,105

(22) Filed: Jul. 31, 2010

(51) Int. Cl. G06Q 10/00

(52) U.S. Cl. 705/7.42; 705/7.13

(57) ABSTRACT

A job is divided into multiple discrete tasks that can be performed by multiple different workers of a distributed workforce. The tasks are assigned to the workers through their mobile phones or other communication devices, and the workers perform the assigned tasks and provide responses to the tasks through the devices. Workers are compensated, in part, based in part on the quality of their responses. Once the workers' responses have been determined to be sufficiently accurate, the responses are assembled into a final result. To manage the distributed workforce, the system stores information for each worker, such as an identification of the worker, the tasks previously completed by the worker, and the quality of performance of those tasks. The stored worker information is used to assign tasks to workers, to compensate workers, and in general to manage the workforce.

### BACKGROUND

This invention relates generally to managing a workforce distributed over electronic communication networks, and more particularly to compensating workers in a distributed workforce for performing tasks.

Many processes that an organization, such as a business, need to perform can be divided into a number of discrete tasks that must be performed manually. For example, a business may need a human to review and classify a large number of pictures, as this process may not be feasible to perform using a machine. To classify each picture, in this example, a human may use a computer system to access and view each graphical image, determine how to classify the image, and then enter the classification into the computer system. The tasks that are required to complete a process may be performed by a single person, who may be an employee of the organization. Alternatively, since the tasks can be discrete, the tasks may be distributed to and performed by a number of different people, and the results of the tasks later combined to complete the process.

In many cases, the local labor that is available to an organization may not always be appropriate for the tasks, depending on the work that the organization needs to be performed. In a wealthy industrialized country, for example, the local workforce may not be willing to perform relatively small tasks for a relatively small reward, whereas workers from other areas in the world might be willing to do the work for the compensation that the organization is willing to pay. The proliferation of electronic communication networks, such as the Internet and cellular networks, has increased the availability of workers who are located remote from the businesses and organizations that could benefit from their labor. Nevertheless, sending tasks to a distributed workforce still presents many logistical issues.

The use of a large group people to perform multiple discrete tasks is often referred to as “crowdsourcing.” Existing crowdsourcing systems typically do not have compensation systems that are directed at the quality of the responses provided by the crowd. As a result, these systems fail to motivate people to perform tasks well and thus fail to achieve a high quality of results from the contributors. These and other limitations of crowdsourcing have rendered it inappropriate for solving the needs of many organizations that have tasks that must be performed reliably and economically.

### SUMMARY

Economic rewards are provided to the workers of a distributed workforce based on the quality of their performance on the tasks. Various compensation schemes may be used to motivate the workers to perform the tasks well. For example, workers may be compensated based on the expected value of their response or based on the performance during a previous period. Workers may also be compensated for their correct responses, for finding errors in other workers' responses, or for the performance of other workers whom they manage, and workers may be provided with bonuses for reaching certain quality or productivity levels. In addition, the rewards can be provided in various forms, both economic and non-economic. Economic rewards may include direct payments, valued added to a wireless services account, gift certificates, discounts or coupons, virtual currency, donations to charity, and lottery tickets, and non-economic rewards may include promotions, certifications, access to information, access to computing resources, and other economic opportunities, just to name a few. By compensating workers based on performance, various compensation schemes can better motivate the workers to perform well, ultimately lowering the overall labor costs associated with the distributed workforce.

### BRIEF DESCRIPTION OF THE DRAWINGS

FIG. 1 illustrates the relationships among various entities in a distributed workforce, in accordance with one embodiment of the invention.

FIG. 2 illustrates a system for managing tasks and workers in a distributed workforce, in accordance with one embodiment of the invention.

FIG. 3 is a block diagram of the job processor server of FIG. 2, in accordance with one embodiment of the invention.

FIG. 4 is a block diagram of a work sever of FIG. 2 in accordance with one embodiment of the invention.

FIG. 5 illustrates a process for registering a worker, in accordance with one embodiment of the invention.

FIGS. 6A and 6B illustrate a process for managing the performance of a job by a distributed workforce, in accordance with one embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Management System for a Distributed Workforce

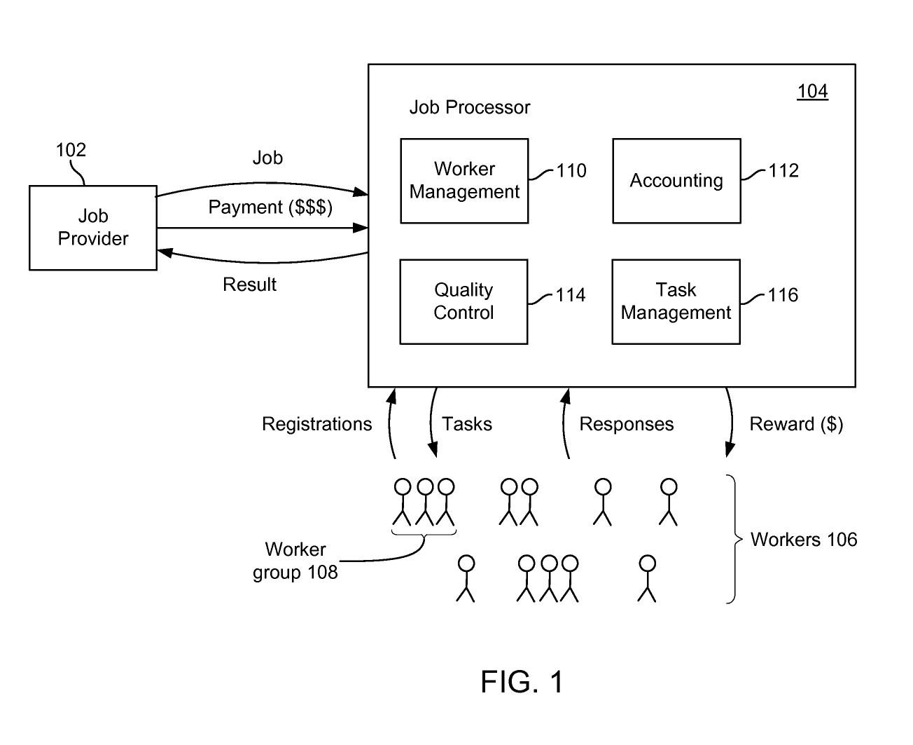

FIG. 1 illustrates the relationships among various entities in one embodiment of a distributed workforce. A job provider 102 sends a job that it desires to have completed to a job processor 104. The job provider 102 may be an individual, organization, business, or any other entity that needs work to be performed on its behalf. The job processor 104 is an entity that organizes the tasks and their completion on behalf of the job provider 102. The job provider 102 may also submit a payment to the job processor 104 as compensation for performing the job. In one implementation, the job processor 104 is a service provider that offers distributed workforce management services for a number of job providers 102, which are clients of the job processor 104.

The job processor 104 completes jobs for the job provider 102 using workers 106. The job processor 104 uses a number of systems to carry out its processes, including worker management 110, quality control 114, accounting 112, and task management 116. After the job provider 102 sends a job to the job processor 104, the job processor 104 divides the job into a number of discrete tasks that can be performed individually and separately. The job processor 104 then assigns the tasks to workers 106, receives responses (i.e., answers to the assigned tasks) from the workers 106, and then submits an overall job result to the job provider 102. The job processor 104 keeps track of the individual workers 106 and has information about the workers 106 and their past performance of tasks. This information allows the job processor 104 to assign more appropriate tasks to each worker 106 and thus to achieve a higher quality result for each of the overall jobs.

Workers 106 receive tasks from the job processor 104, perform the tasks, and submit responses to the job processor 104. Workers 106 may also initially register with the job processor 104 to enable the job processor 104 to better track and identify the workers 106. For clarity, in the description below, workers 106 are considered to be individual persons. In other embodiments, a worker 106 may comprise a group of people, a corporation, or another entity. In other embodiments, the system may also use automatic algorithms (e.g., image recognition routines) to perform some of the tasks that might otherwise be performed by human workers. Workers 106 may be divided into worker groups 108 that share a common connection or property, as described further below. Workers 106 may be provided with various types of rewards for completing tasks and submitting responses.

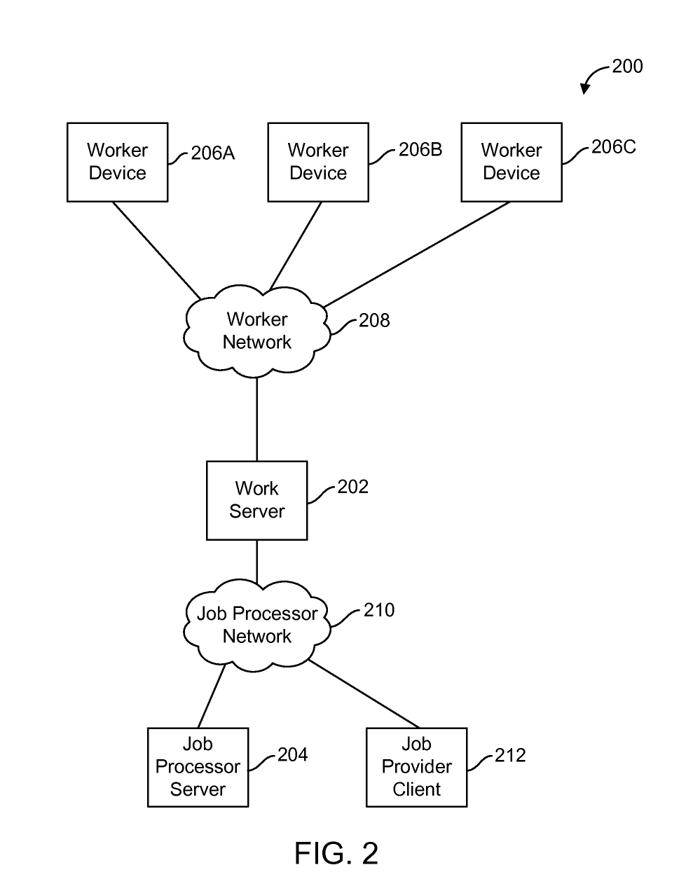

FIG. 2 illustrates a system 200 for managing tasks and workers 106 in a distributed workforce, in one embodiment. The system 200 includes a job processor server 204, a job provider client 212, a work server 202, and worker devices 206. A job provider 102 interacts with the system through the job provider client 212. The job provider client 212 may be any computing device, such as a workstation or mobile computing device. The job provider may submit jobs, view job status, submit payment, and receive results through the job provider client 212. The job processor server 204 is a computing device that carries out the functions of the job processor 104 described above, including worker management and task division and assignment. In one embodiment, the job processor server 204 is a server with significant storage and computing capabilities to allow for handling many job providers, workers, jobs, and tasks.

The worker devices 206 are computing devices for use by workers 106 to interact with the system 200. Workers may use the worker devices 206 to register with the system, receive tasks, submit responses, and view feedback and rewards, in one embodiment. Worker devices 206 may be inexpensive mobile devices, such as basic cell phones with text messaging capabilities, which are readily available and widely used in many developing countries. The worker devices 106 may also include computers in public internet cafes, which the workers may log into and use from time to time. These are just a few examples, however, and the worker devices 106 may be any suitable type of device that enables a worker to communicate with the work server 202 to engage in any of the actions described herein in connection with the worker devices 106.

The work server 202 provides an interface for the worker devices 206 to the job processor server 204. The work server 202 may receive registration messages from worker devices 206 and perform a portion of the processing of the registration messages (e.g., bouncing bad registration requests) before the new worker is added to the databases of the job processor server 204. The work server 202 may receive task assignments in bulk from the job processor server 204 and send the tasks to individual worker devices 206. The work server 202 may similarly receive responses from the worker devices 206 and send them in bulk to the job processor server 204. In one embodiment, the worker server 202 handles local communication issues with the worker devices 206. For example, if a worker device 206 is a cell phone, the work server may communicate via text messages with the cell phone. The job processor server 204 does not need to be aware of the particular communication methods and protocols used between the work server 202 and the worker devices 206.

The job processor server 204, job provider client 212, and work server 202 are connected by a job processor network 210. This may be any type of communication network, such as a corporate intranet, a wide area network, or the Internet. The work server 202 communicates with the worker devices 206 through a worker network 208. This may also be any type of communication network. In one embodiment, the worker network 208 is a cellular network that supports text messaging, and the worker devices 206 are cell phones. Although only three worker devices 206 are shown, there may be many (e.g., hundreds, thousands, or more) in the system 200. Similarly, there may be many work servers 202 and job provider clients 212 that communicate with job processor server 204. There may also be multiple job processor servers 204, such as for redundancy or load balancing purposes.

In one embodiment, the workers 106 may be geographically located remote from the job providers 102. For example, the job provider client 212 and job processor server 204 may be located in a developed country with good network connectivity and the work server 202 and worker devices 206 may be located in a developing country with poor network connectivity. In this case, buffering may be performed between the job processor server and the work server in order to decrease latency and data loss. This buffering may be performed by components of the work server 202 and job processor server 204, or it may be performed by other computers and additional networks.

In another embodiment, a simplified network configuration may be used, where the worker devices 206, work server 202, job processor server 204, and job provider client 212 are all connected to the same network (e.g., the Internet). This may be used if all the devices have good connectivity to the same network. In one embodiment, the job processor server 204 and work server 202 may be the same computer.

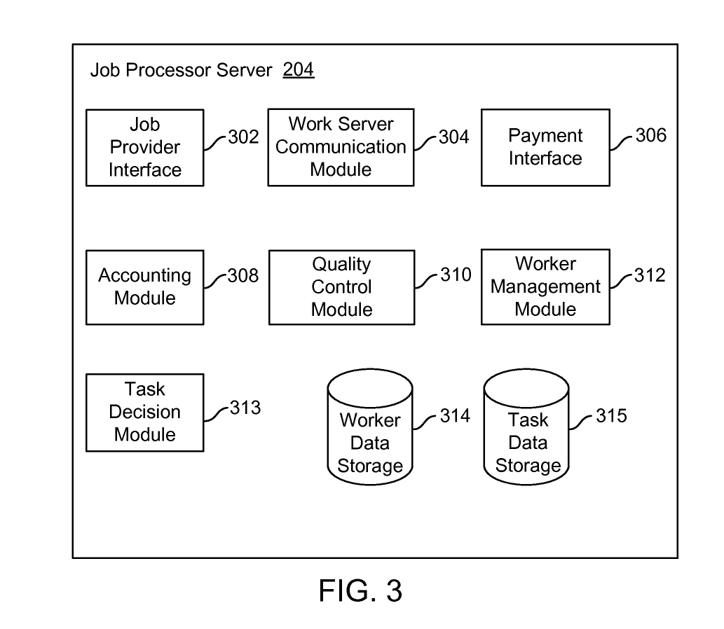

FIG. 3 is a block diagram illustrating the job processor server 204, in one embodiment. The job processor server 204 includes a job provider interface 302, a work server communication module 304, a payment interface 306, an accounting module 308, a quality control module 310, a worker management module 312, a task decision module 313, a worker data storage 314, and a task data storage 315.

The job provider interface 302 interacts with the job provider client 212. In one embodiment, the job provider interface 302 includes a web server to provide the job provider client 212 with a web-based interface to submit jobs and receive results. The work server communication module 304 communicates with the work server 202, including sending tasks (possibly in bulk) and receiving responses. The accounting module 308 determines rewards to be given to workers for their completion of tasks. The payment interface 306 handles payment transactions with the job provider and workers. The payment interface 306 may interface to various financial payment systems. These processes are described in more detail below.

The quality control module 310 determines the quality of worker responses and job results. The worker management module 312 keeps track of workers, including information about workers, relationships between workers, and past performance of workers. The task decision module 313 divides jobs into tasks and assigns tasks to workers. The worker data storage 314 stores information about workers. This information may be stored by the worker management module 312 and accessed by the task decision module 313. The task data storage 315 stores information about tasks, such as the tasks needed for a particular job and the status of these tasks (e.g., assigned, completed, etc.). The task data storage 315 may be accessed by the task decision module 313. In one embodiment, the worker data storage 314 and task data storage 315 are stored on a storage device of the job processor server 204. These processes are also described in more detail below.

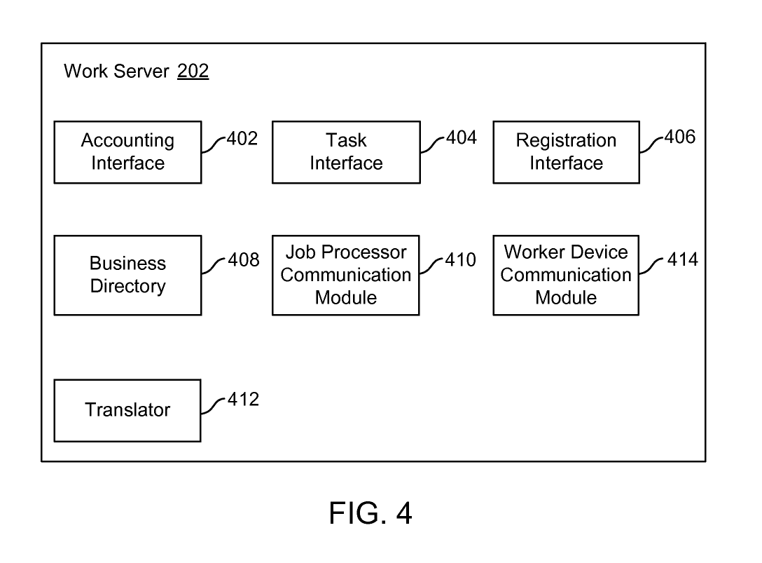

FIG. 4 is a block diagram illustrating the work sever 202, in one embodiment. The work server includes an accounting interface 402, a task interface 404, a registration interface 406, a business directory 408, a job processor communication module 410, a translator 412, and a worker device communication module 414.

The accounting interface 402 provides an interface to worker device 206 for rewards. For example, a worker device can check rewards or be notified of rewards by the accounting interface 402. The task interface 404 notifies worker devices of tasks, receives task responses, and provides an interface for other task-related issues. The registration interface 406 enables workers to register through worker devices, and it receives and processes registration messages. The job processor communication module 410 handles communications with the job processor server 204, which may include buffering of information to be transmitted over the job processor network 210. The worker device communication module 414 handles communications with the worker devices 206, which may include buffering of information to be transmitted to the worker devices 206 over the worker network 208. For example, the worker device communication module 414 may convert tasks into text messages and provide them to a Short Message Service (SMS) gateway.

The business directory 408 may include a directory of local businesses that can be used for task generation or assignment as further discussed below. The translator 412 can translate messages into a language understood by workers. For example, a task may be received from the job processor server 204 in one language, and the task can be translated into another language before being sent to the worker device 206.

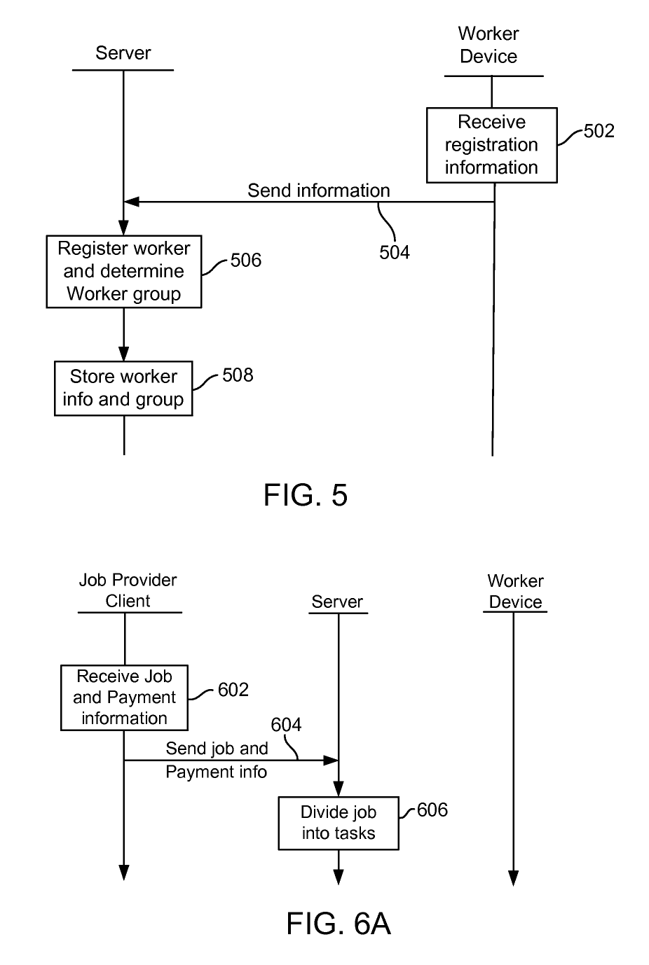

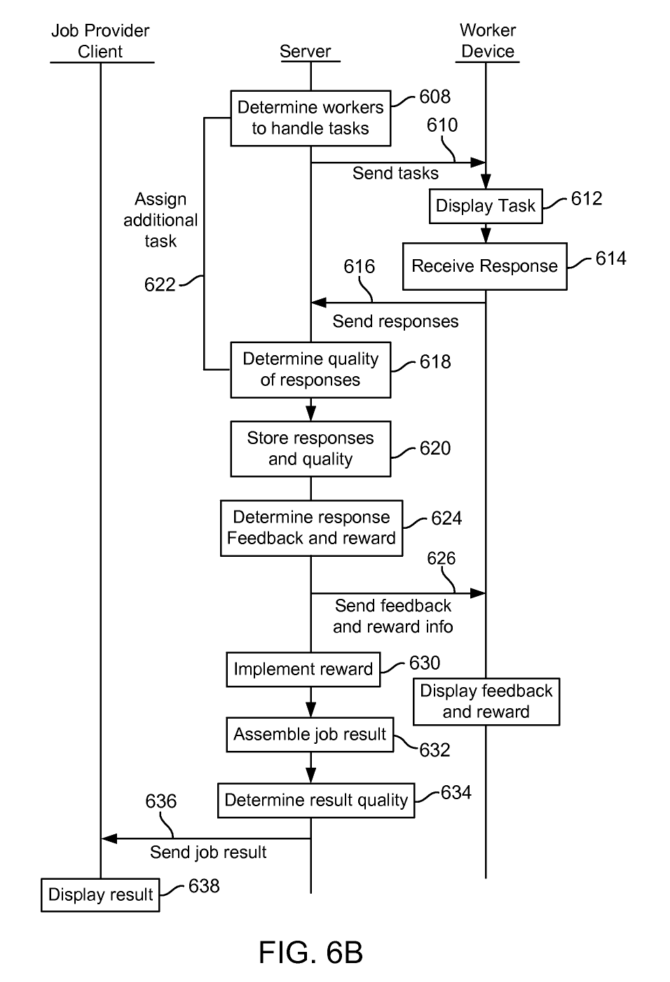

Some of the functionality of the work server 202 described above may be included in the job processor server 204, in some embodiments. Similarly, some of the functionality of the job processor server 204 described above may be included in the work server. Also, as mentioned above, the job processor server 204 and the work server 202 may be the same computer. In the processes illustrated in FIGS. 5-6 and described below, the job processor server 204 and work server 202 are combined into a single entity, which is referred to as the “server” for ease of description. In an embodiment with a separate job processor server 204 and work server 202, the job processor server 204 and the work server 202 communicate with each other to perform the functions of this server.

### Tracking and Managing Workers

FIG. 5 illustrates one embodiment of a process for registering a worker 106. As mentioned above, workers may register with the system so that they can be tracked and assigned appropriate tasks. Initially, registration information is received 502 at a worker device 206 from the worker (e.g., input into a user interface of the worker device 206), and this information is sent 504 to the server. For example, a worker may enter a text message into his or her worker device 206 that includes various registration information and then sends the text message to a phone number or SMS code associated with the server. The worker may have previously been given instructions on what to include in the text message and what number to send it to. In one embodiment, the worker may input and send data multiple times during registration. For example, the worker may send a first text message with some information, receive a response from the server, and then send further information in a second text message. In one embodiment, registration information is provided via a web-based form that is displayed on the worker device.

The information sent to the server from the worker device 206 may include various types of information about the worker and other information that may be of relevance in assigning tasks, evaluating responses, or determining rewards. Examples of information include the name of the worker, the location of the worker (e.g., city or postal address), age, gender, or other demographic or socio-economic information. Further information may include the worker's desired types of work (discussed further below), the worker's desired quantity of work, and the times that the worker is available to do work (e.g., time of day, days of week). The information may also include how the worker desires to be rewarded. For example, the worker can provide a bank account number for cash rewards to be deposited, or the worker may provide the details of a wireless services account and indicate that the worker prefers to be rewarded with value (e.g., as measured in some kind of currency units) added to the balance of that wireless services account. The worker may also provide information to set up secure future interaction with the system, such as various login questions and answers or a password. Additionally, if the worker device is a cell phone, the server will receive the cell phone number. This number may be used by the server to uniquely identify the worker in the future.

In one embodiment, a worker 106 can register other workers or otherwise indicate a connection to one or more other workers. A worker may serve as a manager of other workers and be responsible in various ways for those workers. In many cases, a manager will personally know his or her subordinates and be able to supervise them outside of the system 200 through personal interaction. For example, a manager may be an adult that is responsible for a group of poor or at-risk teenagers. The manager may register all of his subordinate workers and specify himself as their manager. He may then be rewarded if they subsequently perform well on tasks and penalized if they do not, as further described below. He may also have the power to enable or disable their working privileges at any time. For example, if one of his subordinate workers engages in undesirable behavior, such as skipping school or using illegal drugs, the manager can temporarily halt his working privileges and prevent him from completing tasks or receiving rewards for a certain period of time. In one embodiment, a worker may also indicate workers that he or she knows, even if the relationship is not a managerial one.

Information about personal relationships that are provided to the system 200 may be useful for task assignments and reward determinations. Since a manager may be rewarded or penalized based on the performance of subordinates, the manager may exert influence on subordinates to perform well and provide them with additional motivation. Also, the manager may be able to provide more details about the subordinates' skills and abilities to the system 200 to enable better assignment of tasks to the subordinates. Managers may also be motivated to recruit new workers to perform work for the system 200. Information about non-managerial relationships may also be useful in task assignments, as some tasks may be designed to be worked on cooperatively by a group of workers offline. In such a cooperative task, the rewards of all the involved workers may depend on the quality of completion of the task, resulting in peer pressure among members of the group to perform well.

Returning to FIG. 5, the server registers 506 workers and may also determine worker groups. In one embodiment, registration involves storing registration information associated with a worker in the worker data storage 314. The worker data storage may be a database in which each row corresponds to a worker having a unique identifier (e.g., cell phone number) and the columns correspond to types of information about the worker.

Worker groups to which the worker belongs may also be stored in the worker data storage. One type of group is a group formed by the associations discussed above. For example, a manager worker and associated subordinate workers may be considered a group. Another type of group is a group that is formed based on commonalities in registration information. For example, workers living in the same city may be placed in a particular group even though they do not indicate knowing each other during registration. Workers of similar ages, workers having similar skills, and workers having other similar traits may be placed into groups. Groups may be useful for task assignment purposes as described further below.

In step 508, the server stores worker information and group information in the worker data storage 314, e.g., in a worker profile for each worker. The server may then send a confirmation of registration to the worker device, which displays the confirmation to the worker. Once a worker has been registered, the worker is eligible to receive and perform tasks, and be rewarded for doing so, as described below.

### Performance of a Job by a Distributed Workforce

FIGS. 6A and 6B illustrate a process for managing the performance of a job by a distributed workforce, in one embodiment. A job is received 602 from a job provider via a job provider client 212. For example, the job provider may enter job information into a form on a web browser running on the job provider client 212. The job provider may have previously registered with the system 200 and set up an account with the job processor server 204.

Payment information may also be received 602 from the job provider. The payment information may include an amount specifying how much the job provider is willing to pay. Moreover, the job provider may select from a number of options regarding the cost of the job versus a degree of accuracy of the result (where a higher level of accuracy of the result costs more, because it more likely involves more tasks sent to individual workers, and thus more cost to the job processor). The payment information may also include a method of payment, such as a credit card number, bank account, or other source of funds. Different payments may be specified for different levels of completion of the job or different qualities of results. The job information and payment information is sent 604 to the server.

The job may be any of a wide variety of jobs that may be broken down into several tasks to be performed by the distributed workforce. One example of a job is to translate a book from one language into another. For such a job, the job provider may send the text of the book along with an indication of the desired translation language to the job processor server. Another type of job is image tagging and/or classification. For example, the job provider may have thousands of images taken from a vehicle while driving down a road, where an image is taken every few seconds along the road. The job provider may desire to have each image tagged to indicate whether the image includes a street sign as well as the contents of the sign. Another type of job is entry of data from scanned data entry forms. For example, the job provider may have many scanned forms, where the forms each have several fields containing handwritten information that must be added to a database.

Jobs may also include the classification of various types of documents. For example, a job may be to determine whether various emails from customers are “angry” or not. Based on results provided by the job processor server, the job provider may then take a closer look at these emails to determine what actions might be taken to placate the angry customers. The results of jobs need not be limited to binary classifications. For example, a job may request that various degrees of anger be identified in emails. Alternatively, the job may request a short sentence describing each email. Other types of jobs may involve obtaining classifications, descriptions, or transcriptions of various media items, including images, videos, and audio recordings.

A job may also have multiple stages. For example, a job provider may provide various scanned filled-in paper forms to the job processor server and request that the job processor server digitize the forms and the filled-in values. The job processor server may initially determine the form fields and set up a database having those fields. The job processor server may then create the database records having those fields with the filled-in values.

In addition to processing information provided by the job provider, jobs may involve obtaining new information. For example, a job may be to assemble a directory of businesses in a particular city that includes business names, descriptions, addresses, and photos. The job provider may merely specify the city to the job processor server and rely on the job processor (using the distributed workforce) to obtain the desired business information for the city.

Division of a Job into Discrete Tasks

In step 606, the job is divided into tasks. Task division may be performed by task decision module 313. Jobs may be divided into tasks in a variety of ways. In one embodiment, jobs are divided into tasks that are independent of each other and that can be performed by separate workers. Various factors may be taken into account when dividing jobs into tasks, including the size or difficulty of individual tasks, the ability to verify task responses, and the ability to assemble responses into a job result. Particular tasks may be dependent on completion of other tasks. For example, the first phase of a job may involve a certain types of tasks, while the second phase may involve different types of tasks that work on the responses from the first phase.

Another type of task is a verification task, which may be used to verify the quality of another worker's response to another task. A verification task may involve a worker reviewing the previous response of another worker and specifying whether or not it is correct. Verification may also be performed by simply assigning the same task to multiple workers and analyzing the responses from the multiple workers to determine the likely best response and its likelihood of being the best. Verification tasks may be sent to workers who are known to have higher skill levels, higher dependability, or a better past performance record than workers performing standard tasks.

For example, if a job is to translate scanned pages of a book from a first language to a second language, a first set of tasks may be to transform the scanned page images into text characters of the first language, also known as optical character recognition (OCR). Much of the OCR can be performed by automated OCR algorithms. However, the algorithms may fail on certain images of words or phrases, and these images of words or phrases can be sent to workers as manual OCR tasks. The workers respond with text corresponding to the images. For each image sent out as a task, the job processor server maintains information specifying the location of the image in the book so that the worker responses can be inserted at correct places in the text of the book. Verification tasks may also be created to verify the correctness of the manual OCR tasks. Continuing this example, a second stage of tasks would involve translating the text from the first language to the second language. For this stage, the book can be divided into sentences or paragraphs, and each of these text fragments can be sent to individual workers as translation tasks. The workers provide responses including the requested text in the second language. Since OCR has already been performed, text fragments can be easily sent to workers as text messages, for example. As with the first stage, the job processor server maintains information to enable the responses to be assembled in a correct order to produce a translated book as the final job result. Verification tasks may also be created at this stage.

### Assignment of Workers to Perform the Tasks

The server then determines 608 workers to handle the tasks. The task decision module 313 may communicate with the worker management module 312 to retrieve information about possible workers from the worker data storage 314. Task assignment decisions may be based on many factors, including data provided about workers during registration (or subsequent update of registration information), and including data learned about workers from their past performance of tasks. In the example discussed above about translating text from a first language to a second language, workers can be chosen who are known to understand both the first language and the second language. This can be determined from their registration information (e.g., language skills indicated while registering). It can also be determined from their past performance of tasks, such as whether they have been able to successfully complete tasks in the past in both of those languages. The translation skill of potential workers can be determined from the workers' performances on past translation tasks.

As described further below, when a worker completes a task, the quality of completion may be determined and stored. The information regarding the quality of a worker's performance on previous tasks maybe used to assign subsequent tasks. Various attributes of workers may be learned based on their past performance, including: overall response quality, response quality for different sorts of tasks, quality of responses for tasks requiring particular knowledge or skills, response time, and dependability (e.g., likelihood of receiving a response). Models can be constructed of workers based on this information to predict their likely future performance on various tasks, and these models may be used to assign subsequent tasks. In one embodiment, a machine learning model is trained using many workers' attributes and their performance on tasks, and this trained model is then used to predict a worker's performance on future tasks. These predictions may be used to determine which worker's to assign which tasks, as discussed herein.

Tasks may also be assigned based on worker groups 108. Workers in a particular group may share a common characteristic or otherwise have a relationship among the group members, as mentioned above. If a task requires workers having a particular characteristic (e.g., a skill in a particular language, or a location in a particular city), then the population of workers eligible for the task may be limited to an appropriate worker group. Worker groups may be used to assign tasks to workers who personally know each other, if such an assignment is necessary or is likely to provide increased motivation to the workers to perform the task well. Conversely, worker groups may be used to assign tasks to workers who are unlikely to know each other personally (e.g., who live in different cities) if a lack of connection among the workers for a given job is desirable for security or verification purposes.

In one embodiment, the job processor server 204 does not have knowledge of the current status of specific workers when assigning tasks. For example, the job processor server 204 may not know which workers are currently online and available to receive tasks. In this case, the job processor may determine the required characteristics of potential workers (e.g., particular worker groups needed). This information may then be sent to the work server 202, which can then choose individual workers for task assignments. In another embodiment, workers send messages to the work server 202 indicating when they are available to receive new tasks. For example, a worker may indicate that he or she is willing to receive tasks during the next six hours, or some other time period. In this embodiment, the job processor server 204 may assign tasks to workers based in part on the workers' stated availability o perform the tasks.

The tasks are sent 610 to the worker devices and displayed 612 to the workers. Tasks may include instructions for performing the task and possibly data for processing, such as text, images, audio, or video. The workers then perform the tasks. Task performance may involve manipulating or processing the information provided in the task or may involve the worker obtaining information from outside sources and/or performing some other type of work. Upon completion of the task, a response is received 614 by the worker device 206 from the worker. For example, the worker may enter a text response into his or her cell phone. The task response is then sent 616 to the server.

The server then determines 618 the quality of responses received. As mentioned above, this can be performed through the use of verification tasks. In one embodiment, a specially trained and trusted pool of people may verify a certain fraction of responses (or all responses). Response quality may also be determined through various other methods, such as automated algorithms that can detect clearly incorrect responses (e.g., where a 50-word paragraph is translated into a single word of another language). The received responses and the quality measures determined for the responses are stored 620. In one embodiment, additional tasks may be assigned 622 after some responses are received. If any task responses are determined to be of low quality, the same tasks can be re-assigned to other workers.

If the server is unsure of the quality of a response, the same task can be sent out to multiple workers to determine the correct or best response. For example, the server may look at subsequent responses to confirm a previous response. If the responses from multiple workers differ, the correct or best response may be determined according to the frequency of each response and/or the reliability of the workers providing the responses, among a number of other factors. If task responses of acceptable quality are received, tasks corresponding to the next stage of the job can be assigned and sent to worker devices 206 (in the example above, translation tasks can be sent out after receiving quality responses to OCR tasks).

### Rewarding Workers for Completing Tasks

Response feedback and rewards are then determined 624 for the responses received. The feedback for a given worker's response may indicate the quality of that response. The feedback is useful because it communicates to the worker how well the task was performed, which enables the worker to improve performance for future tasks and incentivizes the worker to do so. The feedback may be expressed as a binary (e.g., good or bad) or numerical (e.g., “5 out of 5 stars”) value, and it may include written indications of quality or other relevant notes (e.g., “75% of verifiers disagreed with your response” or “You did not respond within the requested three-hour period”). The feedback may also include suggestions for improving the worker's future responses (e.g., “Please provide a shorter response in the future”). Feedback may be provided for individual responses from the worker, or it may be provided to the worker in the aggregate for multiple responses. In a hierarchical arrangement of workers, the feedback may be provided to the worker and to any of the worker's supervisors.

Rewards may be determined based on a variety of factors, including the quality of the workers' responses and the difficulty of the tasks. The server may determine the quality of the responses using various techniques, as discussed above, including by assigning verification tasks to other workers. Moreover, the difficulty of a task may be determined in many ways, such as by receiving an indication of the difficulty from the job provider or the job processor, or by requesting the opinion of other workers about the difficulty of the task. For example, one type of worker task may be to rate the difficulty of other tasks, such that one worker's response to a task is used to determine the compensation for another worker's response to a different task.

In one embodiment, workers are compensated based on an expected value of their responses to the system. For example, a system may assign the same task to several workers until a threshold confidence level is reached for the task, at which time the system determines the correct response for the task within an acceptable margin of error. In such an embodiment, the system may keep track of each worker's reputation to predict how often the worker is expected to provide a correct response. A worker's reputation may be based on the historical accuracy of the worker's responses. For more accurate workers, the system would expect to need to assign the same task to fewer workers to achieve the necessary confidence level for the task. This is in part because less accurate workers need more confirming responses before the system can reach the necessary confidence level for a response. Since the system pays workers for their responses to tasks, fewer assigned tasks results in a lower cost to the system. Accordingly, the expected value of a response from a more accurate worker is higher than the expected value of a response from a less accurate worker, regardless of the content of the responses. The system may thus compensate workers differently based on the accuracy of their responses to previous tasks, and this compensation need not take into account the accuracy of the response for which a worker is presently being compensated.

More generally, workers may be compensated for their responses during one period based on their performance during one or more previous periods. This way, workers will earn a known, stable pay for their work for a given period, but they are also motivated to perform well. With a higher performance during one period, a worker can effectively earn a raise for the subsequent period. But with a poor performance, the worker may earn much less in the next period. In such a scenario, the worker with poor performance may be motivated to quit, which would be a small loss to the system. Alternatively, a worker with poor performance could attempt to improve that worker's reputation with a good performance, and thus earn a higher compensation. Beneficially, this provides a path for a worker to rehabilitate the reputation while requiring less investment, since the worker is earning less during this time.

In one embodiment, workers are compensated only if their responses are correct, or at least verified. For example, a response may be verified by other workers' responses, after which the worker may be compensated for the verified response. The verification process also provides opportunities to motivate workers using compensation. For example, a worker may be assigned a task that comprises verifying another worker's response, and the worker may be compensated for identifying an error in the other response and/or for improving or adding to the response being verified. In addition, a worker whose previous response was declared to be incorrect (e.g., based on other workers' responses to a verification task) may be given the opportunity to post a bounty from the worker's own account to “re-grade” the response. If the response is then verified, the worker keeps the posted bounty and also receives additional compensation; otherwise, the worker loses the bounty, which is used by the system to offset the costs of reevaluating the response.

Variable rewards and other types of reward distributions may be used to motivate workers to provide high-quality responses. Among various compensation schemes, the workers may be compensated additionally by improving their quality, accuracy, and/or response time. For example, a worker may receive a bonus compensation for providing a certain number of consecutive correct answers, for achieving a certain accuracy percentage over a period of time or series of tasks, or for providing a certain output of responses during a given period. Workers may also be paid for responding to surveys or questionnaires. Further, workers may be compensated for performing tasks in the real world, which may or may not relate to an assigned task from the job processor. Such tasks may include interviewing someone, recording answers, participating in a “secret shopper” program, rating a consumer experience (e.g., confirming that an item is purchasable), going to a location and gathering or verifying Point of Interest (POI) data, delivering a package for someone (e.g., to help to solve the last mile delivery problem), or any of a variety of actions that can be performed in the real world.

Rewards may also be given to managers for tasks performed by subordinate workers. Good performance by subordinates may result in a bonus being given to the manager, while poor performance by subordinates may result in reduced rewards being given to the manager. This encourages the manager to motivate his or her subordinates to perform more tasks and to perform them well. The compensation in a hierarchical system may also be based on the worker's title. This additional compensation reflects the additional responsibility that accompanies a managerial role, and it encourages other workers to strive for a promotion through good performance of their tasks. Rewards may also be given to an entire group of workers if the workers as a whole perform tasks well. This also encourages members of a group to motivate others in the group to perform well.

Various forms of rewards may be used, including cash payments, credits to various stores, or redeemable coupons. In one embodiment, the reward is a direct payment to a debit card or bank account associated with the worker. If the system does not have access to a bank account for the worker, the system may set up a bank account for the worker at a bank that is local to the worker, fund the account, and give information to the worker necessary to access the account. In another embodiment, the reward comprises an addition of value (e.g., measured in some form of currency) to the wireless services account associated with the worker and/or associated with the worker's cell phone (which may also serve as a worker device 206). This may be particularly attractive for workers on prepaid cell phone plans. In some markets, currency stored in the balance of a wireless services account can be redeemed as real cash (at some local transaction cost) or sent to another person's wireless services account, as a gift or as a payment in exchange for goods, services, etc.

In another embodiment, the reward provided to the workers comprises a PIN-based “gift certificate,” which may or may not be associated with a physical gift card. Accordingly, the PIN associated with the gift certificate can be freed from the card and sent directly to a worker's mobile phone or other computing device. The worker can then redeem the certificate locally. In addition to being redeemable at retail stores or restaurants, the gift certificates may be associated with costs of living, such as electricity bills or rent, or broadly with anything that a worker may need to pay for.

The reward may include a variety of other types of economic benefits for the worker. For example, the reward may include a fee reduction or partial payment of costs on behalf of the worker (e.g., tuition for school, trade programs, or other training to benefit the worker). The reward may also include payment in the form of virtual currency, which may enable online purchases of games, music, movies, or any other computing resource that may be purchased using virtual currency. In one embodiment, the value of the reward (regardless of its form) is randomized. In such an embodiment, the value of the reward may be set randomly, similar to a lottery ticket, where the value has a chance of being relatively large. The random-value reward may also be set with a nonzero minimum to guarantee that the worker earns at least some value. Alternatively, the reward may simply comprise one or more entries to a raffle, where more entries provides the worker with a greater chance to win the prize. In another embodiment, the reward may include a payment to a charity, possibly chosen by the worker, either anonymously or on behalf of the worker.

The reward may include non-economic benefits for the worker. In one embodiment, workers who have performed well may be “promoted” in various ways, and notice of this promotion can be sent to the worker along with the feedback. The reward may also include providing the worker with symbols of the increased status, such as by “badges” that may be displayed via the worker user interface portal and visible to the worker's associates and/or friends. In this way, workers may be motivated to perform well so as to achieve levels of status within their social circles.

After performing certain tasks well, a worker may become qualified to verify or otherwise monitor the performance of other workers on various types of tasks. A worker may also be promoted to a supervisory role and assigned subordinate workers, and a new worker group may be created similar. As discussed above, the compensation scheme may allow a worker who has a managerial role to receive increased rewards for the work of workers under that manager worker. Through promotion, a worker may become qualified to take on different kinds of work (e.g., more difficult and more important work, which may lead to higher payments).

Even in the absence of a specific promotion to a different worker role, a worker may be rewarded with a certification. A certification may indicate that the worker is specially qualified to perform certain tasks (such as translation tasks). Defining different fields of certification may provide the system with a better mechanism to evaluate a worker's responses and to compensate the worker for them. For example, a worker who is certified only in translation may have better opportunities for tasks that relate to translation, but not tasks that relate to image recognition. Also, workers who have been certified for a particular skill may be made directly available to potential employers in a real world marketplace setting, rather than in a strictly managed environment of the distributed workforce discussed herein.

Other non-economic rewards may include access to information, the Internet, or generally to computing resources. For example, the worker may be compensated by providing the worker with access to sports information, weather information, information on how friends did with similar work, training information related to how to do work more efficiently or profitably, or any other type of information that is relevant to a particular worker. The information may be provided in various ways, including over the same network used to send the tasks. Rather than specific information, the compensation may comprise providing the worker with Internet access, such as through mobile phone providers, ISPs, or cyber cafes (which is beneficial where the worker does not own his or her own hardware). For example, a worker may need to do a small amount of work before he or she can check e-mail.

In another embodiment, the worker's reward may simply be to work on a system that is being completed by the workers. For example, a job may be to build a database of local knowledge, such as restaurant reviews. While some users may pay for use of the online service, the workers who are contributing to it may be compensated with the ability to access the service. This compensation scheme may be especially relevant when related to local knowledge outsourcing, where the work relates to learning and verifying locally-relevant information such as prices, locations, ability of services, and the like.

Another type of possible reward to the worker is to provide the worker with economic opportunities, rather than or in addition to direct payment to the worker. For example, the worker may be given more access to work or access to different types of work, or the worker may be given the ability to give friends or acquaintances these opportunities. This may allow the worker to recruit others (for additional compensation), to train others, to edit the work of others, or to work on more difficult—but better paying—work.

In another embodiment, the compensation may include the ability to vote for something, such on an issue related to work and compensation. The more rewarded the worker, the greater voice that the worker has in how the issue is resolved. The voting may also be on an issue that has no effect on the worker, such as an opinion poll.

As mentioned above, workers may provide information regarding their reward preferences and reward receipt methods at registration. This information can also be updated and revised by the workers. The feedback and reward information is sent 626 from the server to the worker device and then displayed 628 to the worker on the worker device. The reward is implemented 630 by various methods depending on the type of reward. Rewards may be provided per-response or in the aggregate (e.g., a single reward for all responses sent each week).

A cash reward may be implemented by sending a payment to a worker's bank account. An airtime reward may be implemented through an interface with an appropriate cellular service provider's account systems. The rewards may be directly paid to an external account for each worker, or the rewards may be initially added to each worker's local account that is managed by the server. The workers may log into the server to manage their accounts, see their account balances (i.e., the money that they've earned), and request to be cashed out. In response to the cash out request, a worker may direct the payment (e.g., to the worker's bank account, wireless services account, etc.), and the server then transfers money in accordance with the worker's instructions. In one embodiment, the payment interface 306 implements the reward.

### Assembling and Providing the Final Result

The server assembles 632 the overall job result from the received task responses. As discussed above, the server may store ordering information regarding the tasks so that the responses can be assembled in the correct order. In one embodiment, the quality of the job result is determined 634 before providing the result to the job provider. The quality of the job result may be determined by applying various algorithms to the known or likely quality of the individual task responses. A determined quality level of the job result may be compared to a threshold quality level for deciding whether the result is of sufficient quality for it to be sent to the job provider. If the result is deemed to be of insufficient quality, further tasks can be sent to workers as described above to produce a higher quality result.

The job result (e.g., the translated text of a book) is sent 636 to the job provider client 212, which may communicate information summarizing the result and/or the quality of the result to the job provider 102. The job provider client 212 may communicate this information to the job provider 102 using any of a variety of mechanisms. For example, the job provider client 212 may display the information to the job provider 102 in a web-based interface. Alternatively, the job provider client 212 may store the information in a computer-readable medium and make it available for downloading by the job provider 102. The job provider client 212 may even make a hardcopy of the information and send it to the job provider 102. In other embodiments, the information need not be communicated to the job provider 102. For example, the job may involve obtaining information about businesses in a city, and the job provider 102 may just have the job processor 104 update an online directory about the city with the job result. Accordingly, the information about the result may be provided to a third party, or the job result may comprise a performed task that need not result in information to be communicated to the job provider 102 (e.g., where the job is the delivery of a package to a physical address).

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, or it may comprise a general-purpose computing device selectively activated or reconfigured by a computer program stored in the computer. Furthermore, any computing systems referred to in the specification may include a single processor or may be architectures employing multiple processor designs for increased computing capability. Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes rather than to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for compensating workers in a distributed workforce, the method comprising:
receiving a job from a job provider;
dividing the job into a plurality of tasks in which each task comprises a request for a response from a worker and the collection of responses for the tasks comprises a result for the job;
assigning each of the tasks to one or more workers of a distributed workforce;
sending the assigned tasks over a communications network to electronic devices associated with the workers to whom the tasks are assigned;
receiving responses for the assigned tasks over the communications network from the electronic devices associated with the workers to whom the tasks are assigned;
determining a quality of performance of each of the tasks based on the responses received from the workers;
determining a reward for each worker based on the determined quality of performance of the task assigned to the worker; and
compensating each worker according to the determined reward for the worker.

2. The method of claim 1, further comprising:
providing feedback to each worker to indicate the worker's determined quality of performance.

3. The method of claim 1, wherein determining the reward for each worker is further based on a level of difficulty of the task assigned to the worker.

4. The method of claim 3, wherein the difficulty of the task for one worker is determined by assigning a task to another worker to evaluate the difficulty of the task.

5. The method of claim 1, wherein the quality of performance for a worker is determined based on an expected accuracy of the worker, which is a function of the worker's historical accuracy on one or more previously completed tasks.

6. The method of claim 5, wherein the reward for a worker is determined based on an expected value of the worker's response, where the expected value is a function of the expected accuracy of the worker.

7. The method of claim 1, wherein the workers are compensated only after the workers' responses have been verified.

8. The method of claim 1, wherein determining the reward for each worker is further based on whether the worker's response corrected a previously incorrect response of another worker.

9. The method of claim 1, wherein a worker is a manager of one or more subordinate workers, and determining the reward for the manager is further based on the qualities of performance of the tasks assigned to the subordinate workers.

10. The method of claim 1, wherein determining the reward for the manager is further based on the qualities of performance of the tasks assigned to a group of workers.

11. The method of claim 1, further comprising:
determining that a particular worker's response does not meet a threshold quality of performance;
receiving a request from the worker to reevaluate the worker's quality of performance;
receiving a bounty from the worker;
assigning a task to another worker to reevaluating the quality of performance of the worker's task;
responsive to determining that the worker's response does meet a threshold quality of performance, compensating the worker and allowing the worker to keep the bounty; and
responsive to determining that the worker's response does not meet a threshold quality of performance, keeping the bounty.

12. The method of claim 1, wherein determining the reward for each worker is further based on whether the worker's response demonstrated an improvement in quality of performance.

13. The method of claim 1, wherein the reward for one or more of the workers comprises a monetary value paid to worker's account.

14. The method of claim 1, wherein the reward for one or more of the workers comprises an addition of value to a wireless services account associated with the worker.

15. The method of claim 1, wherein the reward for one or more of the workers comprises a reward selected from a group consisting of: a PIN-based gift certificate, a fee reduction, a coupon, a payment of virtual currency, a donation of funds to a charity, an entry in a raffle, and a lottery ticket.

16. The method of claim 1, wherein the reward for one or more of the workers comprises a certification of the worker's ability to perform a task, wherein the certification provides the worker an ability to perform additional tasks.

17. The method of claim 1, wherein the reward for one or more of the workers comprises a non-economic reward selected from a group consisting of: access to information, access to the Internet, and access to a computing resource, increased status, use of an online service, and a right to vote on an issue.

18. A method for compensating a worker in a distributed workforce, the method comprising:
identifying a task that comprises a portion of a job, wherein the task comprising a request for a response from a worker;
sending the task to the worker over a communications network to an electronic device associated with the worker;
receiving a response for the task over the communications network from the electronic device associated with the worker;
determining a quality of performance of the task based on the received response;
determining a reward for the worker based on the determined quality of performance of the task; and
compensating the worker according to the determined reward for the worker.

19. A computer program product for compensating workers in a distributed workforce, the computer program product comprising a non-transitory computer-readable storage medium containing computer program code for:
receiving a job from a job provider, the job comprising a plurality of tasks where each task comprising a request for a response from a worker;
assigning each of the tasks to one or more of a plurality of workers;
sending the assigned tasks over a communications network to electronic devices associated with the workers to whom the tasks are assigned;
receiving responses for the assigned tasks over the communications network from the electronic devices associated with the workers to whom the tasks are assigned;
determining a quality of performance of the tasks based on the responses received from each of the workers;
determining a reward for each worker based on the determined quality of performance of the task assigned to the worker; and
compensating each worker according to the determined reward for the worker.
